(19) United States
(12) Patent Application Publication
(10) Pub. No.: US 2012/0179577 A1
(43) Pub. Date: Jul. 12, 2012

(54) SYSTEM AND METHOD FOR PROCESSING GIFTS FROM A GIVER TO A RECIPIENT

(76) Inventors: Thomas M. ISAACSON, Huntingtown, MD (US); Virginia T. ISAACSON, Huntingtown, MD (US)

(21) Appl. No.: 13/429,998

(22) Filed: Mar. 26, 2012

Related U.S. Application Data
(63) Continuation-in-part of application No. 12/967,253, filed on Dec. 14, 2010.

(51) Int. Cl. G06Q 30/06

(52) U.S. Cl. 705/26.41

(57) ABSTRACT

Processing gifts from a giver to a recipient is addressed. The system receives an identification of a product or service as a gift and a recipient. The system transmits an offering including the product/service for selection by the recipient. The system processes the purchase and delivery of the selected product using a recipient payment and delivery account and transfers money from the giver payment account (or a holding account) to the recipient payment account to reimburse the cost of the product. The system can process the purchase and delivery of the selected product using the giver's payment and delivery account. In another embodiment, the system utilizes a group to give a gift to the recipient, each member of the group reimbursing a group giver a portion of the cost of the gift.

### PRIORITY CLAIM

The present application is a continuation in part of application Ser. No. 12/967,253 filed 14 Dec. 2010, incorporated herein by reference.

### BACKGROUND

1. Technical Field

The present disclosure relates to providing an offering of a gift from a giver to a recipient in which the recipient has the ability, via an interaction with the offering, to instantly purchase and arrange for gift delivery. The offering is associated in advance with an on-line payment and delivery account of either the giver or the recipient.

2. Introduction

Choosing and arranging for delivery of an appropriate gift is not always a perfect process. In many instances, a give having good intentions will select and give a gift to a recipient for a special occasion such as a birthday. However, the recipient may not like the gift, or already have one and may want to return or exchange it for a more desirable gift. Another problem is arranging for delivery of digital on-line gifts such as an e-book or software to a device. There is no mechanism for providing such a delivery from a giver. What is needed in the art is an improved way of giving gifts that enables the recipient to receive an appropriate gift that is less likely to be returned. Another feature that is needed to provide a way to give a gift electronically without using a gift card.

### SUMMARY

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Specifically, the present disclosure sets forth solutions to the problem set forth above. There are a number of different embodiments covering various aspects of the solution with respect to the gift being a product that can be delivered to a physical address such as a home, a product that can be delivered electronically to an electronic device or a service that is performed. The embodiments are typically practiced in connection with an on-line service that receives information from the giver to identify a product or service that is to be given to a recipient and generates an offer. The offer presents a product or service to a recipient in which the offer is pre-associated with an on-line purchasing and delivery (where applicable) account. The offer can be extended to the recipient as though the recipient searched an on-line shopping website and navigated to a point where the product or service can be purchased and delivered via a single interaction such as a “one-click” purchase. Various aspects of this solution will be presented next.

The first embodiment relates to generating an offer to place a recipient in a purchasing position using a recipient's on-line purchasing and delivery account. In this case, the system receives from a giver an identification of a product such as a particular book on politics at an on-line shopping environment that the giver desires to give to a selected recipient. The giver may then select the book for purchase and delivery to the selected recipient. After the recipient and the product are identified, an offer can be generated. The offer is pre-associated with an on-line purchasing and delivery account of the recipient. In some cases, the on-line account of the recipient includes a payment account such as a Visa or Mastercard, a delivery address for the recipient, and any other necessary information. Because the presented offer is connected to the recipient on-line account, the offer can be presented such that it is the equivalent of the recipient having searched for the book, and navigated to the point where the recipient can “one-click” purchase the book and have it delivered. The offer can include other information such as details explaining the offer, “Todd wants to give you this book on politics, just click ‘buy now’ and it will be purchased by Todd and shipped to your home in two days.” If the recipient chooses to receive the book, then the system processes the purchase and delivery according to the recipient's on-line account. The recipient's payment account can be used initially to pay for the book, but the cost of the book is reimbursed from the giver payment account or a holding account to the recipient payment account. A holding account can be used to reserve giver funds so that when the recipient accepts his gift, there is sufficient funds available to reimburse the recipient. In this manner, the recipient can choose whether they want the book included in the offer.

If the recipient does not want the book, then the system can create an environment in which the recipient could continue shopping for a similar book that the giver can buy for the recipient. For example, the system can simulate a situation in which the recipient had searched the on-line shopping environment for political books. The recipient can click on a “continue shopping” button, and the system can present with what appears to be the results of a search for recent political books. The search can be a copy of the search made by the giver or a search created by the environment. In this way, the recipient can view similar products for sale as though the recipient were returning to a set of search results queried by the recipient. At this point, the recipient can navigate the search results as a typical on-line shopping experience using their own account. In one aspect, the recipient can simply use his or her own account for purchasing a product and the giver can contribute to the purchase made by the recipient. Alternately, the system can restrict the cost of products suggested when the recipient selects the “continue shopping” button. For example, an offer extended to the recipient can be for a particular book selected by the giver or any item costing $30 or less. The recipient can easily shop for other desired items restricted by a policy set forth by the giver. For example, if the recipient chooses a pocketknife rather than the suggested book, the cost can be automatically limited to the maximum gift amount the giver wishes to give. After the recipient selects a desired product, the purchase is completed using the recipient payment account, the product is delivered to the recipient, and the recipient payment account is reimbursed from the giver payment account or a holding account for part or all of the cost of the selected product. The holding account can be used to reserve giver funds for reimbursement to the recipient when the recipient chooses a gift.

The second embodiment is similar to the first embodiment but eliminates the need for the reimbursement transaction from the giver to the recipient. In this case, the presented offer is pre-associated with the giver on-line account that includes the giver payment account and various addresses. Typically, the giver on-line account will include also a delivery address for the giver for purchased products. It can also include other delivery addresses such as alternate delivery addresses for the giver and recipient addresses. Thus, the offering can be pre-associated with the giver on-line account with the recipient address selected as the delivery address. If the recipient interacts with the offering to accept the book as the gift, the system will process the purchase and delivery of the book via the giver on-line account. The giver payment account is directly used or a holding account is used to purchase the gift and the recipient address is used for delivery.

Another aspect of the second embodiment can be useful when the recipient opts to “continue shopping” within the on-line environment. The “continue shopping” option can be restricted because the recipient is essentially shopping within the giver on-line account. However, because the system can implement viewing and/or purchasing restrictions set by the giver in the on-line environment, there is no danger that the recipient will select an item outside the price range set by the giver and require the giver payment account to purchase the item. For example, the giver can establish a policy that will guide the continued shopping experience of the recipient. The policy can be based on subject matter such as political books published in the last 6 months, or based on dollar value such as a purchase up to $40. The policy can be based on time, for instance the recipient can be given a time limit such as an hour to search for items and make a gift selection, or items that can be shipped and arrive the next day for the recipient's birthday can be presented. The system provides fields that the giver can interact with to receive the parameters that establish the policy. Then, if the recipient chooses to “continue shopping”, the policy will manage what items are presented for additional searches made by the recipient such that all items that are capable of being purchased fall within the policy. Otherwise, the recipient's shopping experience is typical in their on-line shopping environment as though they had navigated to the on-line environment and were shopping in the normal fashion.

The third embodiment relates to the giver giving a service to the recipient rather than a physical product. Examples of such a service are a weekend getaway at a resort, a pedicure, a haircut, teeth cleaning, boiler inspection, etc. Any item of service can be delivered under this approach. In this embodiment, the giver will select the service using an application. For example, assume that Todd wants to give a pedicure as a gift to Mary. In this first example, Todd knows Mary's schedule and perhaps information such as her birthday. The system can present to Todd (with authorizations) Mary's schedule as well as available time slots at the nail salon. Using the information from Mary's schedule, the nail salon's schedule, and/or any other data, Todd can select several times as part of the offering, making it easier on Mary to receive her pedicure. The offering can be associated in advance with either Mary's on-line account or Todd's on-line account as noted above. For example, “Todd would like to give you a pedicure for your birthday, please accept and select a time: Yes, Monday at 2 PM; Yes, Tuesday at 4 PM.” In this case, Mary can accept the gift and select a time using one-click or in another interaction with a device. Assume Mary accepts Tuesday at 4 PM. The system will either charge Todd's account directly if his on-line account was used, or charge Mary from her payment account, or then reimburse from Todd's account or a holding account used to reserve Todd's funds for reimbursing Mary. Then the system will schedule the appointment on Mary's calendar and the nail salon's calendar. This provides, in essence, the ability to easily pay for and schedule any service for a recipient.

In another aspect, no calendaring is necessary. The recipient can accept the service, and various mechanisms, such as location based services, can notify a merchant that the service has been purchased for the recipient prior to receiving the service. For walk in type services such as an oil change or haircut, an indication on a mobile device or data transferrable to the merchant indicating that the recipient mobile device is in the store, can notify the merchant that the recipient already has paid for the service (although it does not need to indicate that it is by the giver).

In a fourth embodiment, the system enables group giving of a gift. A group can give a gift to a recipient using a gift offering utilizing a giver payment and delivery account or a recipient payment and delivery account as set forth in the different embodiments above. A group can designate one group member as the “group giver” that initially purchases a gift for a recipient using the one-click gift offering. After the recipient selects his desired gift from an offering, the system completes the purchase using the payment and delivery account of the “group giver”. The account of the “group giver” can store information related to the recipient such as email address, mailing address, preferences, browsing history, wish list, received gifts, etc. Then the system can transfer money from each of the group member's payment and delivery accounts or a holding account to the “group giver” payment and delivery account to cover the cost of the group gift.

For example, a group consisting of Ryan, Gary and Steve wishes to give a gift to Mary for her upcoming birthday. The system designates Ryan as the “group giver” that will initially pay for the selected gift. Any mechanism for determining or identifying the group is possible. The group may determine via input that a toaster is the appropriate gift. An offering is generated that can be pre-associated with the product (a toaster in this case) and either the giver's payment and delivery account or the recipient's payment and delivery account is utilized. After Mary interacts with the offering to accept the product, which is presented on any type of device, the system processes the purchase of the toaster using the account associated with the offering, Ryan's payment and delivery account or Mary's payment and delivery account. For example, an algorithm can be used to determine which account or registration profile to associate with the offering. The system can transfer money from each contributor's payment and delivery account, in this instance Gary and Steve, to reimburse Ryan for their portion of the cost of the gift to Mary. Alternately, the system can utilize a holding account, where money is placed by various group members until Mary accepts the offer or selects a new gift. Each group member, including Ryan can contribute money towards the gift that is held in the holding account. Once Mary selects the gift, Ryan's account can be used to carry out the transaction based on the amount of money in the holding account. Utilizing a holding account can be beneficial because the funds for Mary's gift are reserved until she accepts the offered gift or selects a new gift. This prevents a situation where a group member may have promised to contribute a certain amount of money toward a gift, but have maxed out the credit card they desired to use to pay for the gift. Or a particular giver may commit $50 to the gift but later when the gift is accepted, the giver may only have $30 in his or her account and thus cannot contribute. Thus, all or part of the amount can be withdrawn at a first time and held in a holding account. The amount that is withdrawn can be based on an analysis of the patterns of use of the giver account. For example, if the pattern of use indicates a high likelihood that the money will be there over time to cover the cost of the gift when the recipient chooses to accept the gift, then the money for the gift may stay in the giver account. If the likelihood approaches a threshold that indicates that the giver may not be able to support a withdrawal to cover the committed gift, then the system can withdraw some or all of the money for the gift and place it in a holding account. Utilizing group giving in the context of one-click gift offering utilizing a giver or recipient payment and delivery account allows for a group of friends to effortlessly and seamlessly give a group gift to a recipient.

In a fifth embodiment, the delivery mechanism of a gift is an electronic device instead of a physical address. A giver can select an electronic book, game or application for a particular device such as an Apple® iPad or Amazon® Kindle. In addition to storing a physical address, the giver and/or recipient payment and delivery account can store addresses for delivering data such as an email address, facetime ID, phone number, IP address for portable devices, or any other identification that can be used to be associated with a device. The ID might be “Mary's Kindle” or “Mary Jones' Apple ID account.” A giver can identify an electronic product such as a computer game and then select the recipient device the product should be delivered to. Additionally, the giver can add comments, a video message, text message, hyperlink, delivery timing or any other feature related to giving an electronic product. The system can place the electronic product for download in a queue such that when the recipient's device is communicating with an appropriate network, the download can begin. In one aspect, the recipient does not interact with the device to accept the gift; the gift can downloaded to the device and the recipient can be presented with a message indicating the gift has been downloaded to the recipient's device. In another aspect, the recipient can interact with an offering to accept the download provided by the giver. Additionally, the giver can schedule the electronic delivery for a certain time by utilizing the recipient's calendar or any other method such as location, for example when the recipient is at an airport waiting to board a plane.

In another aspect of this embodiment, the system connects the recipient with a recipient payment and delivery account in which the recipient device can be listed as the destination location for the recipient. The system, using the approaches discussed above such as immediate delivery or triggered delivery based on events, can charge the recipient payment account and deliver the electronic product to the device selected. The cost of the electronic gift can be reimbursed to the recipient payment account by the giver payment account or by a holding account designed to reserve funds for reimbursement. Part of the money can come from the giver account and part from the holding account. This would be the case where the system withdraws some of the money to cover the gift from the giver account and holds it in the holding account. The giver account might hold the money until delivery of the gift or the money might be drawn from the giver payment account to the holding account. All of part of the money can stay or can be moved to the holding account at different times. For example, 60% can be withdrawn and stored in a holding account at a first time, and the remainder withdrawn later.

Additionally, the delivery address of an electronic product may not necessarily be a specific device but optionally on a server such as the Apple® cloud. In this case multiple devices can be synchronized to receive the content from the cloud. The giver can choose to place the electronic product in the cloud-based location of the recipient, using an immediate, triggered or timed delivery. When the product is placed in the cloud, the recipient has the flexibility to determine which device(s) to download the gift to that are associated with the cloud-based account.

An environment such as Amazon.com is one example environment in which account information for givers and recipients is easily obtainable. This includes payment account data and delivery data for products that are shipped. Such environments can include a database of user accounts that already store credit card or gift card, PayPal, or other payment related information. For example, a server can provide an interface in which a giver that is logged into an Amazon.com account can identify a recipient, for example based on an email address, name, username or other personally identifying information. If such a recipient also has an Amazon.com account, the system and/or a merchant system can obtain credit card and debit card information via a secured communication. Most amazon.com accounts, in order to facilitate one-click purchasing, store credit/debit card information as well as delivery information. In this scenario, once the giver is identified, the giver's credit/debit card is already identified as well as the giver's delivery address and other delivery addresses that are in the giver's on-line account. As the giver identifies the recipient, the recipient credit/debit card account can be easily identified for the appropriate embodiment disclosed herein to thus enable the processing of the purchase and delivery of a product or service and reimbursement where applicable.

Also disclosed are various systems and non-transitory computer readable media performing the methods and functions set forth herein. Transitory computer readable media and signals per se also represent other embodiments disclosed.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a system embodiment of a one-click gift offering utilizing a recipient payment and delivery account;

FIG. 3 illustrates a method embodiment of a one-click gift offering utilizing a recipient payment and delivery account;

FIG. 4 illustrates an exemplary user interface for a gift request;

FIG. 5 illustrates an exemplary gift offering preview;

FIG. 6 illustrates an exemplary gift offer;

FIG. 7 illustrates a method embodiment of a one-click gift offering utilizing a giver payment and delivery account;

FIG. 8 illustrates a system embodiment of a one-click gift offering utilizing a giver payment and delivery account;

FIG. 9 illustrates a method embodiment of a one-click gift offering utilizing a group of givers; and

FIG. 10 illustrates a method embodiment of a one-click gift offering utilizing electronic delivery.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Any particular function disclosed in connection with one embodiment or aspect can expressly be integrated into another disclosed embodiment, function or aspect. This disclosure considers mixing and matching of the various functions although particular functions are not specifically discussed in one example.

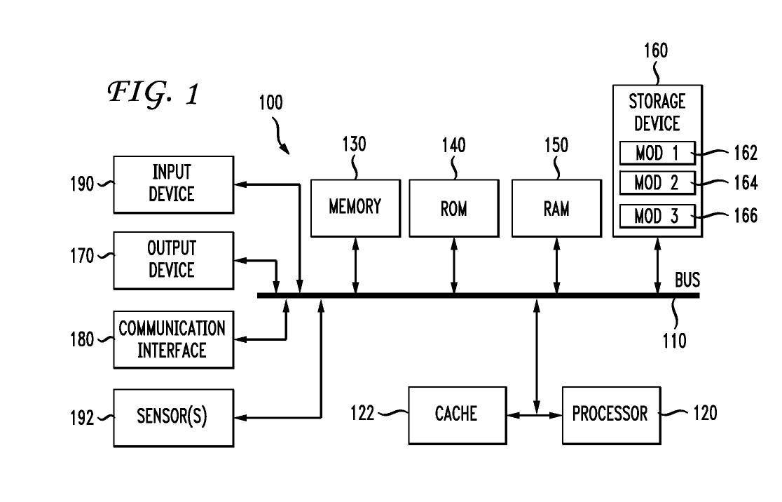

The present disclosure addresses the need in the art for removing hurdles in giving, redeeming, and processing gift cards and particularly to gift cards that are given and redeemed without a physical gift card or gift code. A brief introductory description of a basic general-purpose system or computing device in FIG. 1 that can be employed to practice the concepts is disclosed herein. A more detailed description will then follow of the various credit/debit processing infrastructure, the exemplary methods, and other financial processing infrastructure and concepts in conjunction with virtual gift cards that are redeemed using an existing payment mechanism transparently, that is, without any additional physical gift card, gift certificate or any gift code. A recipient of a virtual gift card can simply purchase a qualifying good or service with her Visa card, for example, and the payment processing infrastructure associated with the Visa card applies the virtual gift card amount automatically to the transaction. This disclosure involves more than just a direct transfer of money from one person to another, or from a gift card to a credit card account, but rather focuses on a gift card approach in which a gift card is established at a first time having a policy, and a recipient, at a second time that is later than the first time, executes a purchasing transaction according to the policy. When that transaction is detected, the system will implement the policy and apply the gift card funds at a third time which is later than the first time, and can be approximately around the second time or later than the second time. The implementation and use of such a policy to guide/manage gift card payment through a recipient's use of an existing account introduces many novel features that are disclosed herein.

The policy can include at least one of: a class of goods or services, an amount of money, a merchant or group of merchants, a ceiling amount of money to be used in the gift card, a time frame for use of the gift card, one or more recipient accounts that when used can trigger the transfer of money from the giver account to the one or more recipient accounts, and a predetermined period of time in which if all the amount of money associated with the gift card is not used according to the policy, a remainder amount of money is transferred from the giver account or a holding account to the recipient account. Part of the remainder amount can come from the giver account and part from a holding account or from another merchant account that in the intervening time has offered to contribute some of the amount for the gift. Thus, the reimbursement can come from a group of sources.

A new result of this approach is to render a recipient open-loop credit/debit card account into a hybrid open-loop/closed-loop account. The system monitors the activity of the account such, that for an average purchase, the account is open-loop and not restricted, but the application of the gift card to specific purchases according the policy is considered closed loop.

For the sake of clarity, the methods herein are discussed in terms of an exemplary system 100 as shown in FIG. 1 configured to practice the method. The steps of each method outlined herein are exemplary and can be implemented in any combination and/or permutation thereof, including combinations that exclude, add, or modify certain steps. These and other variations are discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high-speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs hard disk 160, those skilled in the art should appreciate that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general-purpose DSP circuit, may also be provided.

The logical operations of the various embodiments are implemented as: (1) a sequence of computer-implemented steps, operations, or procedures running on a programmable circuit within a general use computer, (2) a sequence of computer-implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

The term “system” or similar terms also apply to the herein disclosed systems for processing various types of transactions. There are differences in systems for processing credit card and debit card transactions. It is assumed that with the policies and processing disclosed herein, that appropriate adaptations are made for specific systems where necessary. Those of skill in the art will understand the hardware components used for accomplishing such transactions.

The physical systems performing the functions disclosed herein can be found in any geographic location. For example, one or more of the banks, servers, and physical infrastructure performing the steps herein may be outside the United States. Therefore, all processes should be interpreted as also including the concept of a recipient performing a purchase in the United States, communications leaving the United States (confirmation, authorization, instructions, etc.) for a foreign entity, and communications being received from the foreign entity that achieves the results discussed herein.

### Offering a Gift Using a Recipient On-Line Account

The first embodiment of the disclosure relates to generating an offer of a gift that places the recipient in a purchasing position as though the recipient had navigated to a position in a recipient on-line purchasing and delivery account to simply interact with the environment to purchase a product and automatically have it delivered. The system receives from a giver an identification of a product that the giver desires to give to a recipient, such as a book on politics. The giver may then select the book and interact with the environment to select a recipient of the book. The giver desires to give (purchase and have delivered) the book to the recipient. An offer can be generated once the product and recipient are identified.

Because the product and the recipient are known, the offer can be pre-associated with an on-line purchasing and delivery account of the recipient. In some cases, the on-line account of the recipient includes a payment account such as a Visa or Mastercard, a delivery address for the recipient, and any other information such as preferences, default values, and so forth. Because the offer that is presented is connected to the recipient on-line account, the offer can be presented such that it is the equivalent of the recipient having searched for the book, and navigated to the point where the recipient can “one-click” purchase the book and have it delivered via their on-line account. The offer can include other information such as details explaining “Todd wants to give you this book on politics, just click ‘buy now’ and it will be purchased by Todd and shipped to your home in two days.” If the recipient chooses to receive the book, then the system processes the purchase and delivery according to the recipient's on-line account. The recipient's payment account can be used to pay for the book, but the cost of the book will then be reimbursed from the giver payment account or from a holding account to the recipient payment account. The holding account can be used to reserve giver funds so that when the recipient accepts the gift and reimbursement is necessary, the promised funds are available. A holding account can be useful so that the giver does not spend the promised funds prior to reimbursing the recipient. For example, the amount promised to pay for the gift can immediately be charged to the giver's credit card and transferred to the holding account so the giver does not max out his credit card prior to transferring the promised funds to the recipient. Part of the funds can be transferred to the holding account. A merchant in the intervening time could also offer extra discounts to encourage the recipient to accept the gift, such as an extra 5% off. If a situation such as this arises, then after the recipient accepts the gift, and if the recipient payment account is used to pay for the gift initially, then the reimbursement can come from one or more accounts. For example, the reimbursement can partially come from the giver payment account, partially from a holding account, and/or partially from a merchant account. The approach disclosed herein provides for such flexibility in transferring money between the accounts to enable the reimbursement to be fulfilled, and to enable extra offers and incentives from merchants to be possible. This approach can address the problem identified above in which recipients of gifts sometimes do not want the gift and desire to go through the painful process of a return. In this case, the recipient can preview the gift and determine whether to accept.

If the recipient does not want the book product, then the system can create an environment in which the recipient could continue shopping for a similar book that the giver can buy. For example, the system can simulate a situation in which the recipient had searched the on-line shopping environment for political books. If the recipient clicks on a ‘continue shopping’ button, the system presents to the recipient with what appears to be the results of a search for recent political books. The search can be a copy of the search made by the giver or can be generated by the system. In this way, the recipient can see other available similar products. The system generates the simulated search result so the recipient can select a product similar to the offered gift. The benefit of this approach is that it easily presents to the recipient many other options for selection than what was originally presented in the offer. Additionally, the recipient is comfortable shopping because they are virtually placed in a typical on-line shopping environment using their own account.

In one aspect, a recipient can simply use his own account for the purchase of the gift and the giver can contribute to the selected gift. Alternately, the system can restrain the continued shopping option in this environment to a dollar amount limit set by the giver. For example, the offer extended to the recipient can be for the suggested book or any item with a maximum price of $30. The recipient can easily shop for other items they might want but the results would be restricted by a policy set forth by the giver. Then, if the recipient ends up choosing a pocketknife rather than the suggested book, the cost is automatically limited to the maximum gift amount the giver wants to give. Once the recipient selects a desired product, the product can be purchased and delivered to the recipient. The recipient payment account can be reimbursed from the giver account or from a holding account for all or part of the cost of the product. The holding account or the giver account can hold money prior to the purchase, even if the purchase is at a later time. Alternately, the system can debit the giver payment account for at least part of the amount of money towards the gift and the amount of money can be held in a holding account until the purchase is finalized. Portions of the amount of money can be moved to the holding account at various times throughout the process.

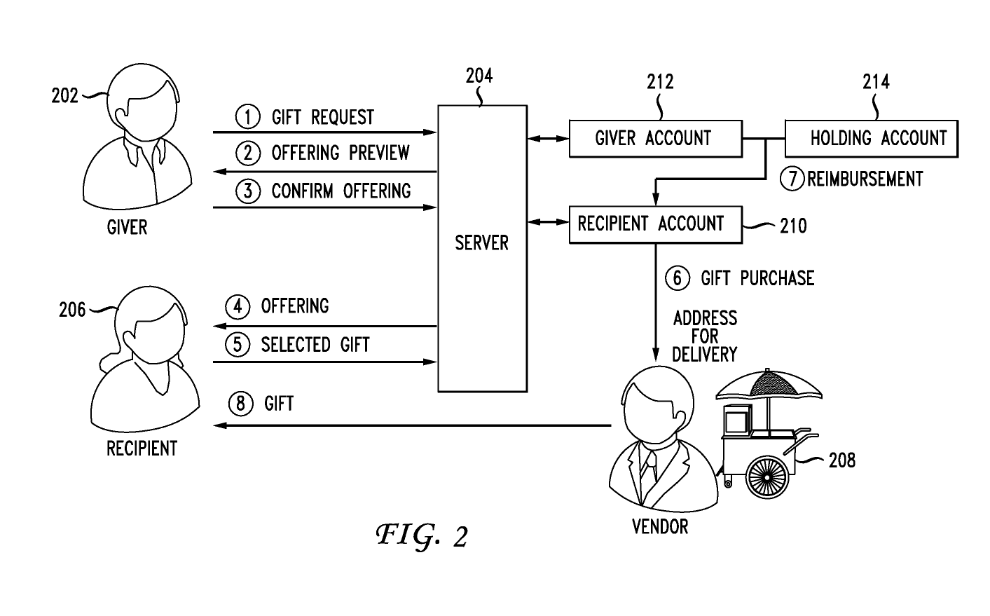

FIG. 2 illustrates a system embodiment of a one-click gift offering utilizing a recipient on-line payment and delivery account. A giver 202 desiring to give a gift electronically using a one-click gift offering, can submit a gift request to a server 204 at an on-line shopping environment. The server can process the gift request and generate an offering preview that includes at least one product for confirmation by the giver. The giver can confirm or modify the offering generated by the server before returning a confirmed offering to the server. At this stage, the interface can also enable the giver to select and structure the “continue shopping” experience of the recipient. For example, if the product desired is the latest political book on the president, the giver may believe that the recipient might already have the book, but also know that the recipient loves all political books. The policy that governs the continued shopping option could be that it will only include political books up to $40 in value. Then, if the recipient already had the political book offered, the “continue shopping” option can present other political books that the recipient can choose from as the gift.

The server can extend the confirmed offering to the recipient 206 for approval of the product within the offering. Once the recipient interacts with the offering to approve the product, the system completes the purchase of the product and delivery by a vendor 208 using the recipient's payment and delivery account 210. The system transfers at least a portion of the cost of the product from the giver's payment account 212 or from a holding account 214 to the recipient's payment account to reimburse the recipient for the purchase of the gift. Lastly, the system arranges for delivery of the gift from the vendor to the recipient based on delivery address information stored in the recipient's account. The delivery address for the book could be any device such as a Kindle or an iPad or any device that can receive electronic delivery of a product. The timing of product delivery can also be specified. For example, if the purchase is for a rented movie, the recipient device could have the movie available during a long trip with an appropriate notification.

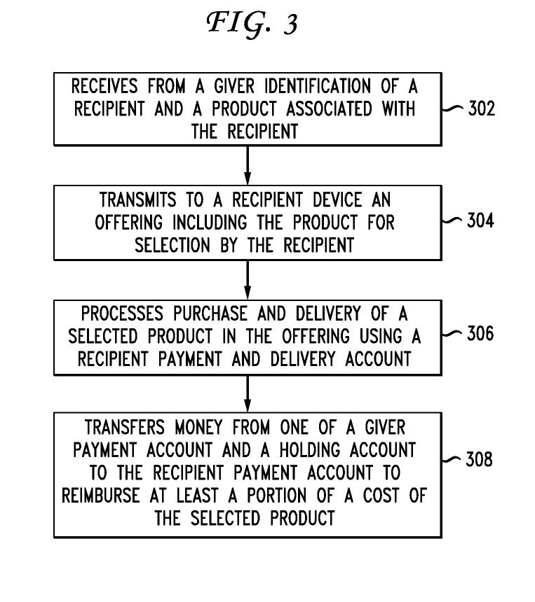

FIG. 3 illustrates a method version of the first embodiment of a one-click gift offering utilizing a recipient payment and delivery account. A system 100 receives from a giver having a giver payment account, identification of a recipient and identification of a product associated with the recipient at a first time (302). The product can be a gift associated with the recipient, either a tangible object such as a book or an intangible service such as a magazine subscription. The system 100 transmits to a recipient device such as a smartphone or other mobile device at a second time which is later than the first time an offering including the product for selection by the recipient (304). Prior to the transmission, the offering is associated with a recipient payment and delivery account that includes a recipient payment account and address delivery information or electronic device identification or cloud account information for the recipient. Upon receiving a selection from the recipient of a selected product in the offering, the system 100 processes purchase and delivery of the selected product using the recipient payment and delivery account (306). The system transfers money from the giver payment account or a holding account (or both) to the recipient payment account to reimburse at least a portion of a cost of the selected product prior to the second time (308).

In another aspect, the method includes receiving, from a giver, identification of a recipient and identification of a product associated with the recipient at a first time, wherein the giver is associated with a giver payment account, transmitting, at a second time which is later than the first time, to a recipient device an offering including at least the product for selection by the recipient wherein the offering, prior to the transmitting, is associated with a recipient payment and delivery account in an on-line shopping environment wherein the recipient payment and delivery account includes a recipient payment account and address delivery information for the recipient. The recipient payment account and the giver payment account in one aspect have no control over one another and each existed prior to the first time. In other words, the system uses a pre-existing giver payment account and a pre-existing recipient payment account. The registration profiles or accounts with the on-line shopping environment having other delivery data also existed prior to the first time. Utilizing existing user accounts renders this approach simple for the giver and recipient.

Upon receiving a selection from the recipient of a selected product in the offering, the system processes a purchase and a delivery of the selected product using the recipient payment and delivery account and transfers money from one of the giver payment account and a holding account to the recipient payment account to reimburse at least a portion of a cost of the selected product, wherein at least a portion of the cost of the selected product is either held in the giver payment account or transferred from the giver payment account to the holding account prior to the second time. This approach described above can apply to any transaction disclosed herein.

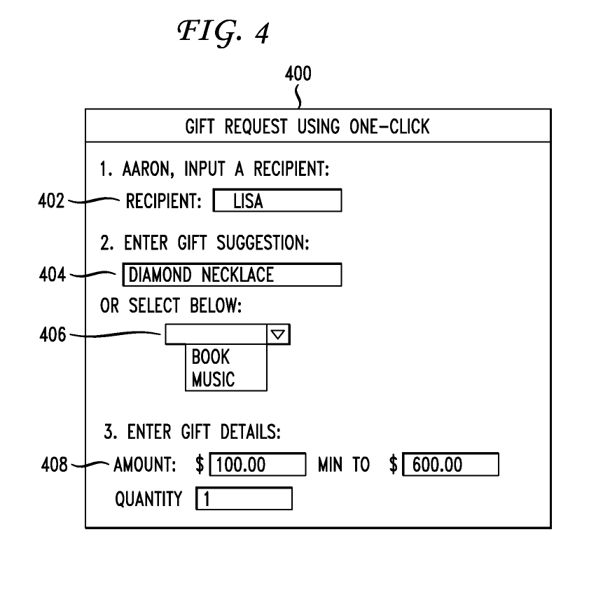

FIG. 4 illustrates an example gift request using a one-click gift offering utilizing a recipient payment and delivery account. The giver 202 can submit a gift request 400 to the server 204 to send a gift to a recipient using a one-click gift offering. The gift request can include a field for a recipient 402 that is associated with the giver. A recipient 206 can be associated with a giver 202 when information related to the recipient is stored in the giver's payment and delivery account 212. For example, the giver can store address delivery information for the recipient in addition to other information such as electronic device delivery information for the recipient, preferences and dates of important events related to the recipient, including birthday and anniversary dates. Data from a social network can be linked to the giver's payment and delivery account manually or automatically, and can be based on the relationship in the social network. The giver can input a gift suggestion 404 for example, a diamond necklace or the giver can select from a drop-down menu of gift suggestions 406 for the recipient. Gift suggestions can include products such as recently released books and music or a service such as a magazine subscription. Alternately, the server can suggest one or more gifts for a specific recipient based on information stored in the recipient's account such as a wish list, preferences, browsing history and past gift information such as received gifts. The gift request 400 can include gift amounts such as a minimum and maximum amount of money 408 the giver is willing to spend on a gift for the recipient. Optionally, the gift request can include additional information such as quantity, greeting, manufacturer, color, availability, shipping cost, delivery date, number of products to include in the preview, etc. A message such as a birthday greeting, anniversary, holiday or congratulatory note can be included in the request as well as an amount allotted for shipping cost and a desired delivery date for the gift. For example, if a giver Aaron desires to gift his wife (the recipient) a diamond necklace for their upcoming anniversary using a one-click gift offering, he would input the desired gift, a diamond necklace, in the gift request 404. Aaron would enter the amount of money he is willing to spend on the diamond necklace in the request, for example a minimum of $100 and a maximum of $600. Optionally, he can input an anniversary greeting and a delivery date for the diamond necklace so it arrives on their anniversary.

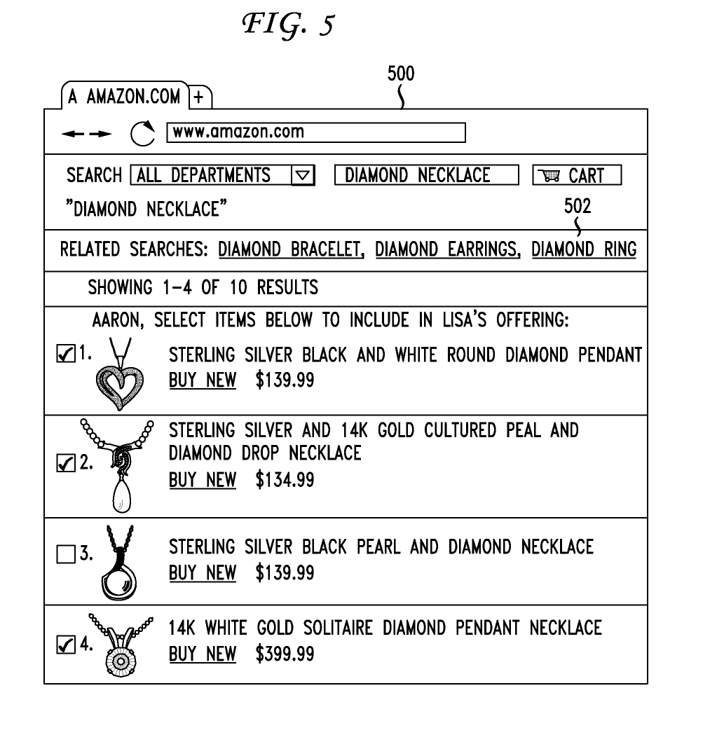

FIG. 5 illustrates an exemplary gift offering preview 500 using a one-click gift offering utilizing a recipient payment and delivery account. The server 204 receives a gift request 400 from the giver 202 and can automatically generate the offering preview 500 based on the information provided by the giver 202 in the gift request 400. The offering preview can include products that meet the requirements set forth in the gift request such as description, price range, color, manufacturer, delivery date, cost, etc. For example, the giver Aaron requested one diamond necklace as a gift within the price range of $100-$600. The offering preview returned by the server includes up to ten results of suggested diamond necklaces that meet the requirements specified in the gift request. The giver Aaron can select desired diamond necklaces to include in the offering to the recipient Lisa from the offering preview supplied to him by the server. For example, Aaron can select items one, two and four from the offering preview. Additionally, the offering preview can suggest related products in addition to the requested product such as a diamond bracelet and diamond earrings 502. Providing the giver with related products in the offering preview can help the giver give the best gift possible by gifting the recipient coordinating gifts, for example. For example, if Aaron does not like any of the diamond necklaces in the offering preview, he can deselect all of the necklaces and choose instead to receive an offering preview of diamond bracelets. Alternately, Aaron can decide that offering a diamond bracelet in addition to a diamond necklace would be an especially thoughtful gift. In one aspect, the giver can manually select diamond necklaces for the offering preview after performing a search within an on-line shopping environment such as Amazon.com for necklaces that he thinks his wife would like and that meet his gift requirements. Additionally, the offering preview can include products both selected automatically by the server and manually by the giver.

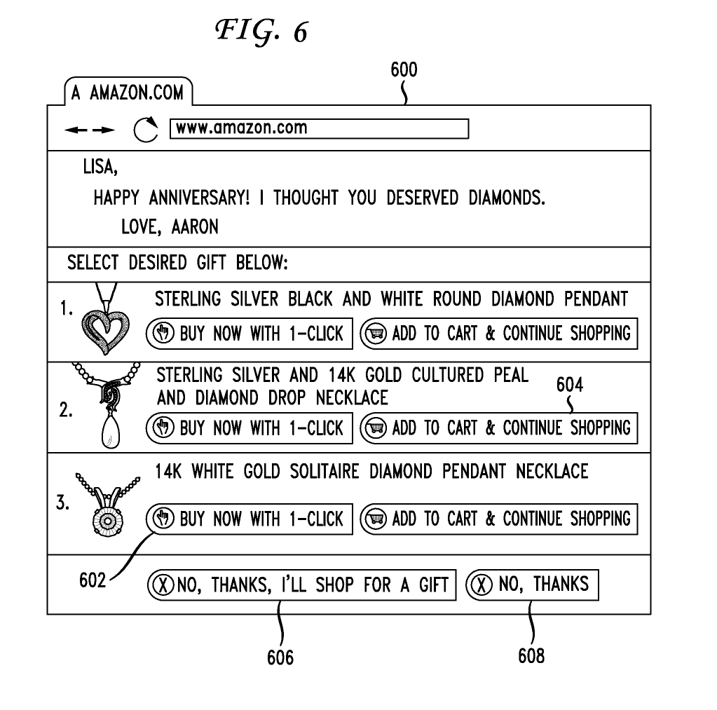

FIG. 6 illustrates an exemplary offering viewed on a mobile device such as a smartphone from a giver to a recipient. The offering includes products approved by the giver, in this case the giver 202 narrowed down gift options to three diamond necklaces. The recipient, Lisa can receive the offer electronically for example through her email and with one-click she can purchase 602 the diamond necklace she desires from the offering. The system 100 automatically transfers at least a portion of the cost of the gift from the giver's payment and delivery account to the recipient's payment and delivery account to cover the cost of the gift. Optionally, the recipient can choose to add one of the necklaces as her gift to her on-line shopping cart and continue shopping 604 for other items at Amazon.com. When the recipient checks out from the on-line store, the system automatically transfers at least a portion of the cost of the gift from the giver's payment and delivery account to the recipient's payment and delivery account. Should the recipient be unsatisfied with the offering she can opt to not accept the offering and instead use the money allotted for a diamond necklace to purchase a gift of her choice at Amazon.com 606 or reject the offering all together 608. The recipient can decline the offering and the system can display a default gift suggestion webpage at the on-line shopping environment that includes a variety of typical gift ideas or a specific gift suggestion webpage based on the recipient's preferences, wish list, browsing history, received gifts, etc. Alternately, the recipient can decline the offering and the system can back out of the offering as if the recipient clicked the “back” button on a browser and the system can display more products related to the gift specified by the giver. For example, from the offering 600, when the recipient selects “No thanks, I'll shop for a gift” 606 the system displays a webpage having more options for diamond necklaces as if the recipient had performed a search for diamond necklaces. The recipient can continue to browse for a desired gift from this webpage. From this point, the recipient can browse products in the on-line shopping environment and select her gift. Additionally, should the recipient decline the offering and instead choose her own gift by browsing, she can select a gift that is either more or less than the amount of money the giver specified. For example, the recipient can select a gift that is significantly less than the amount of money the giver had allocated and the system can store the leftover funds in the recipient's payment and delivery account to apply to a future purchase at the on-line shopping environment. The recipient can select a gift that is more than the amount of money the giver allocated for the gift and the system can deduct the remaining cost of the product from the recipient's payment and delivery account after the giver's payment is applied. Any combination of the ideas set forth is possible and should not be limiting in any way.

### Offering a Gift Using a Giver On-Line Account

The second embodiment is similar to the first but eliminates the need for the reimbursement transaction. In this case, the offer that is presented is pre-associated with the giver on-line account that includes the giver payment account and various addresses. Typically the giver on-line account will include also the giver delivery address for purchased products. It can also include various other delivery addresses, including the recipient address. Thus, the offering can be preassociated with the giver on-line account with the recipient address selected as the delivery address. If the recipient interacts with the offering to accept the book as the gift, the system will process the purchase and delivery of the book via the giver on-line account. Then the giver payment account or a holding account is used to pay for the gift and the recipient address is used for delivery. The holding account can reserve the giver's funds or part of the giver's funds so that the giver does not spend the money committed to paying for a gift.

The other aspect of this second embodiment can also be useful where the recipient can “continue shopping” within the on-line environment, although can be restricted since the recipient is essentially shopping using the giver on-line account. However, since the system can restrict what can be viewed or purchased in this on-line environment to parameters set by the giver, there is no danger that the recipient will continue shopping and select an expensive item, requiring the giver payment account to pay for the item. For example, the giver can establish a policy that will guide the continued shopping experience of the recipient. The policy could be based on subject matter such as political books published in the last six months, or based on dollar value such as a purchase up to $40. The policy could be based on time, such that the recipient is given an hour to search for items and make a gift selection, or alternately only items that can be shipped and arrive the next day for the recipient's birthday can be presented. The system provides fields that the giver can interact with to receive the parameters that establish the policy. Then, if the recipient chooses to “continue shopping”, the policy will manage what items are returned for additional searches made by the recipient such that all items that are capable of being purchased fall within the policy. Otherwise, the recipient's experience is typical in their on-line shopping environment as though they had navigated to the on-line environment and were shopping in the normal fashion.

In another embodiment, a one-click gift offering utilizing a giver payment and delivery account without the use of a recipient payment and delivery account is discussed. This embodiment differs from the one-click gift offering utilizing a recipient payment and delivery account discussed above in that the recipient does not purchase the gift using her payment and delivery account and receive reimbursement from the giver payment and delivery account, but rather the gift is purchased directly from the giver's account or a holding account and delivery information for the recipient is stored in the giver's account.

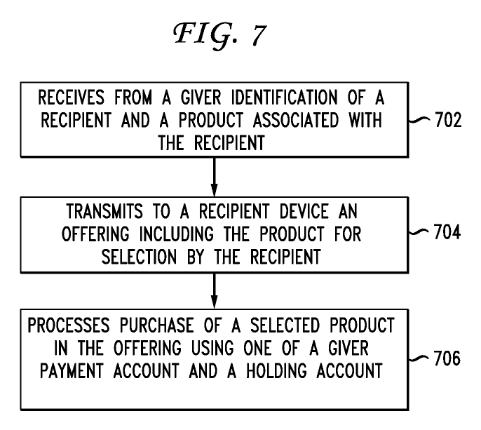

FIG. 7 illustrates a method embodiment of a one-click gift offering utilizing a giver payment and delivery account. A system 100 receives from a giver identification of a recipient and identification of a product associated with the recipient at a first time (702). The product can be a gift associated with the recipient, either a tangible object such as a book or an intangible service such as a magazine subscription. The system transmits to a recipient device an offering including the product for selection by the recipient (704). A recipient device can include a smartphone or other mobile device. Prior to transmitting an offering, the offering is associated with a giver payment and delivery account that includes a payment account of the giver and address delivery information for the recipient. Then, upon receiving a selection from the recipient of a selected product in the offering, processing purchase of the selected product in the offering using one of a giver payment account and a holding account (706). At least a portion of the cost of the product is either held in the giver payment account or transferred from the giver payment account to the holding account prior to the second time. Delivery information for the recipient is held in the giver payment and delivery account. In one aspect, rather than using a payment account of the giver, the system may withdraw an amount of money to pay for the gift from the giver account and store it in a holding account. Then, when the offering is presented, it replaces essentially the holding payment account for the giver payment account such that when the recipient accepts the offer, the payment is made from the holding account. This is an approach that can be utilized if it is questionable that the giver payment account could later support or have sufficient funds to support the actual purchase by the recipient.

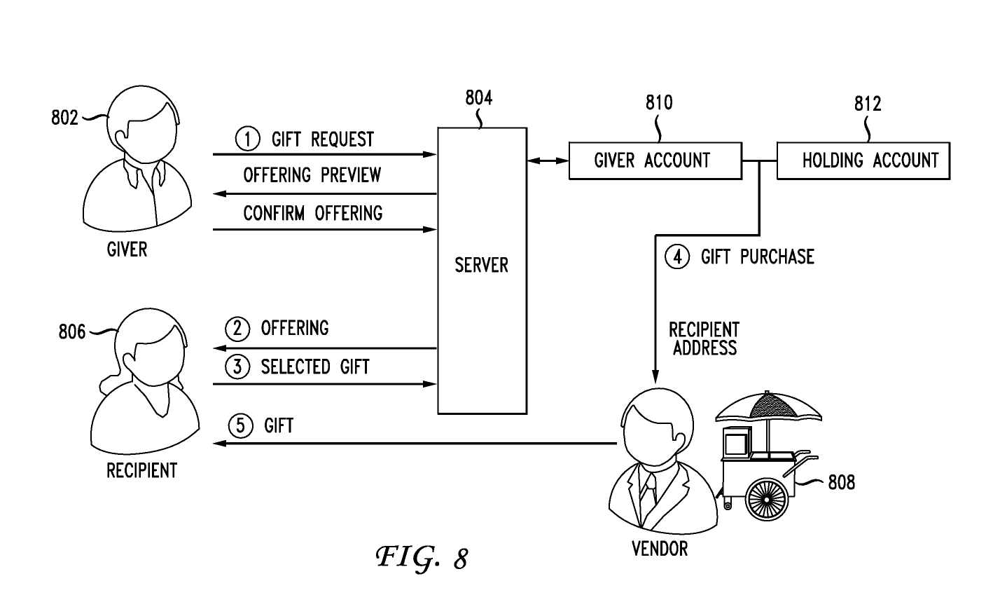

FIG. 8 illustrates a system embodiment of a one-click gift offering utilizing a giver payment and delivery account. A giver 802 desiring to give a gift electronically using a one-click gift offering, can submit a gift request to a server 804 at an on-line shopping environment. The server can process the gift request and generate an offering preview that includes at least one product for confirmation by the giver. The giver can confirm or modify the offering preview generated by the server before returning a confirmed offering to the server. The server can extend the confirmed offering to the recipient 806 for selection of a gift within the offering. Once the recipient selects a gift, the system completes the purchase of the gift via a vendor 808 using the giver's payment and delivery account 810 or using funds reserved in a holding account 812. The holding account can be used to reserve funds to pay for the gift so that the giver does not accidently spend the promised money for the gift. The system can use a holding account and can, based on an algorithm, determine whether to withdraw none, some or all of the funds associated with the gift from the giver payment account to the holding account. The algorithm can produce a result regarding a likelihood that over time the giver payment account will maintain sufficient funds to support a reimbursement of the money for the gift when the recipient accepts the gift. Lastly, the system arranges for delivery of the gift from the vendor to the recipient based on delivery address information stored in the giver's account. For example, a giver Aaron desires to give a gift to his wife (the recipient Lisa) for their anniversary. Aaron can complete a gift request 400 requesting a diamond necklace as a gift within the price range of $100-$600 and can submit it to the server. The server can generate an offering preview including suggested diamond necklaces for Aaron to confirm. Aaron can accept or modify the offering preview before sending a confirmed offering to the server. At this point, the server sends the offering to the recipient, Lisa for selection of a gift. The recipient can accept one of the offered gifts using one-click purchasing utilizing the giver's payment and delivery account, she can decline the offering or she can decline the offering and instead shop for a gift through the on-line shopping environment utilizing the giver's payment and delivery account. After the recipient selects her gift using one-click purchasing, the system utilizes the giver's payment and delivery account 810 to purchase the gift from the vendor. Alternately, the system can use a holding account 812 to purchase the gift from the vendor. The system uses address delivery information for the recipient stored in the giver payment and delivery account. In addition to payment information and address delivery information for the recipient stored in the giver's payment and delivery account, other information such as email address, preferences, recipient wish list, recipient browsing history, etc. can be stored in the giver's payment and delivery account. Optionally, information related to potential recipients can be stored in the giver's payment and delivery account based on association through a social network. Information related to the recipient can be automatically transferred or manually added by the giver.

### Offering a Service Using the Recipient or Giver On-Line Account

The third embodiment relates to the giver not giving a tangible, deliverable product but rather how a giver can give a service to the recipient. Examples of such a service might be a weekend getaway at a resort, or a pedicure, or a haircut, teeth cleaning, boiler inspection, etc. Any item of service can be delivered under this approach. In this embodiment, the giver will select the service using an application. For example, assume that Todd wants to give a pedicure as a gift to Mary. In this first example, Todd knows generally Mary's schedule and perhaps such information as her birthday. The system can present to Todd (with authorizations) Mary's schedule as well as available time slots at the nail salon. Using the information from Mary's schedule, the nail salon's schedule, and/or any other data, Todd can select a few good times to present as part of the offering to make it easy on Mary to receive her pedicure. The offering can be associated in advance with either Mary's on-line account or Todd's on-line account as noted above. For example, “Todd would like to give you a pedicure for your birthday, please accept and select a time: Yes, Monday at 2 PM; Yes, Tuesday at 4 PM.” In this case, Mary can accept the gift and pick a time all in one-click or in another interaction with a device. Assume Mary accepts Tuesday at 4 PM. The system will either charge Todd's account directly if his on-line account was used or charge Mary from her payment account, and reimburse from Todd's account and/or from a holding account used to reserve Todd's funds for payment of the gift. Additionally, the system can schedule the appointment on Mary's calendar and the nail salon's calendar. This method provides the ability to easily pay for and schedule any service for a recipient.

In another aspect, the recipient can accept the service without calendaring. Various mechanisms, such as location based services, can notify a merchant that the service has been purchased and the recipient does not pay when the service is performed. For walk in type services, an indication on a mobile device or data that can be transferred to the merchant identifying that the recipient mobile device is in the store, can notify the merchant that the recipient has already paid for the service (although it does not need to indicate that it is by the giver).

### Group Gift Giving Using a Recipient On-Line Account or Giver On-Line Account

In a fourth embodiment, the system enables group giving of a gift. The concept of giving a gift using a one-click gift offering utilizing a recipient payment and delivery account or a giver payment and delivery account can be applied to multiple givers desiring to pool their resources to give one or more gifts to a recipient. In the first case, utilizing a recipient payment and delivery account, instead of the system 100 transferring money from one giver payment and delivery account to the recipient's account as reimbursement for the cost of the gift, the cost of the gift can be divided between multiple givers based on pledged amounts. The group can decide to divide the cost of a potential gift evenly among all of the members, or each member can pledge a certain amount of money or maximum amount of money toward the group gift. The system can transfer money from each of the group member's payment and delivery accounts to the recipient's payment and delivery account or to a holding account to cover the cost of the group gift. The holding account can reserve some or all of the funds promised to pay for the gift. For example, if Ryan, Gary and Steve desire to give a group gift to Mary, they can decide to split the cost of her gift evenly up to $50 each. If Mary selects a gift from her offering that costs $120, each group member pays $40 toward the group gift. The system charges Mary's payment and delivery account and/or the holding account and the system can automatically transfer $40 from each group member's payment and delivery account to Mary's payment and delivery account to cover the cost of the group gift.

A group can designate one group member as the “group giver” that initially purchases a gift for a recipient using the one-click gift offering. After the recipient selects his desired gift from an offering, the system completes the purchase using the payment and delivery account of the “group giver”. The account of the “group giver” can store information related to the recipient such as email address, mailing address, preferences, browsing history, wish list, received gifts, etc. Then the system can transfer money from each of the group member's payment and delivery accounts to the “group giver” payment and delivery account to cover the cost of the group gift. Alternately, the system can purchase the gift using funds stored in the holding account if there is the possibility that one or more members of the group may not have the money available in their accounts when the purchase is completed, because the purchase is at a later time. This way, the system can guarantee that Mary can receive a gift using the promised funds.

In another aspect, after the gift is offered, a merchant can receive that information and insert within the offering presentation to the recipient an advertisement or additional discount. For example, the offering may say “Mary, Fred is buying this book for you, click here to accept!” Elsewhere, the offer can include “Mary, Barnes and Noble is offering an additional $5 off on this book to make it easier for Fred to buy if you accept.” Then, if Mary accepts the book, then it becomes $5 cheaper for Fred to buy than he originally expected. He may get a reimbursement to his account if all the money was withdrawn to a holding account or he may simply not have as much taken out when the reimbursement occurs.

For example, a group consisting of Ryan, Gary and Steve wishes to give a gift to Mary for her upcoming birthday. The system designates Ryan as the “group giver” that will initially pay for the selected gift. Ryan can offer to be the one who uses his payment account to initially pay for the gift. Any mechanism for determining of identifying the group can be used. The group may determine via input that a toaster is the appropriate gift. An offering is generated that can be pre-associated with the product (a toaster in this case) and either the giver's payment and deliver account or the recipient payment and delivery account. After Mary interacts with the offering to accept the gift, which can be presented on any type of device, the system processes the purchase of the toaster using Ryan's payment and delivery account. An algorithm can be used to determine which account (the group giver's or the recipient's) to associate with the offering. The system transfers money from each of Gary's and Steve's payment and delivery accounts to reimburse Ryan for a portion of the cost of the gift to Mary. Utilizing group giving in the context of one-click gift offering utilizing a giver or recipient payment and delivery account allows for a group of friends to effortlessly and seamlessly give a group gift to a recipient.

The process of sharing the payment for the group gift can occur in any number of ways. For example, if the group identifies a gift, such as a toaster, members of the group who are not using their account to reimburse the recipient's payment account can have their appropriate proportions drawn from their accounts and paid into the group giver's account (Ryan in this case). Thus, Gary and Steve contribute directly to Ryan's account prior to the offering. Then, the offering can be generated and presented via a device to Mary. Mary can accept the gift and have the purchase processed through her payment and delivery account. The group giver's account (Ryan) is charged for the purchase and Mary's payment account can be reimbursed. If Ryan's account is used as the context for presenting the offering to Mary, then no other transfer is necessary since Gary and Steve's portions of payment have already been processed.

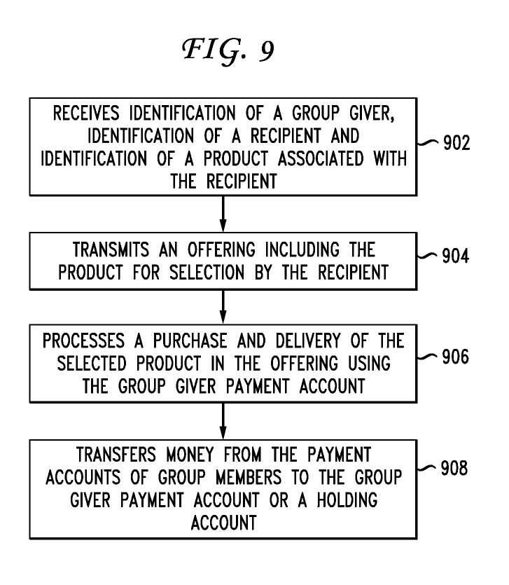

FIG. 9 shows an example method of processing the group gift. First, the system receives an identification of a group giver, identification of a recipient and identification of a product associated with the recipient at a first time (902). Each group member can be associated with their own separate, existing payment account. Depending on the type of gift (product or service) and/or on other factors, the system transmits, at a second time which is later than the first time, an offering including the product for selection by the recipient (904). Prior to the transmitting, the offering is associated with a group giver payment and delivery account, that includes payment information for the group giver and address delivery information for the recipient. Upon receiving a selection from the recipient of a selected product in the offering, the system processes a purchase and delivery of the selected product using the group giver payment account (906). Then the system transfers money from payment accounts of group members to the group giver payment account and/or a holding account used to hold money from group member until the completion of the purchase (908). At least a portion of the cost of the selected product is either held in the group giver payment account and/or transferred from the group giver payment account to the holding account prior to the second time. Utilizing a holding account allows for group members to contribute their monetary portion of the group gift prior to the actual purchase of the gift to prevent members from promising to contribute money and not actually contributing when the purchase is completed. The gift offering can be designed in such a way that the recipient can interact with the offering to accept the gift or can continue shopping as set forth above. Additionally, calendaring or scheduling of a service can be performed. The calendaring might include an appointment or data that is communicated back to one or more of the givers. For example, all of the givers can be notified that an appointment for a gifted manicure is scheduled for Friday at 2 PM.

Once the system receives the acceptance of the gift, the system will process the payment via the on-line account and delivery of the gift if applicable, scheduling of the service, or monitoring of the location of the recipient for indicating pre-payment of the service. Reimbursement of portions of the cost of the gift can occur at any stage of the process such that all of the givers contribute to the gift. It is assumed that each giver can be identified and then associated with their respective on-line account or simply a payment account at that the system will apportion the cost of the gift equally, or by choice manually, and so forth.

In this embodiment or any embodiment disclosed herein, the recipient may also receive the offering with additional data such as multimedia data from the giver for example video, audio messages, generated messages, and so forth. The “environment” can thus partially be the standard on-line environment that the recipient uses to make purchases and schedule delivery, but can also be a hybrid environment. A hybrid environment includes the fundamental functionality to provide payment, delivery and/or scheduling of a service but is also tailored for the fact that the recipient did not navigate to that place. For example, it may be more simple in its presentation, more limited in the scope of capabilities, or modified in some way which can be tailored to more closely align with the fact that the user did not navigate there.

### Electronic Delivery of Electronic Products

In another embodiment, the delivery mechanism of a gift is a device and not a physical address. For example, if a user wants to give an electronic book, electronic game or an application wirelessly, the product cannot physically be delivered to the recipient. A first aspect of this embodiment includes the feature that the giver of the electronic book can store the location of a recipient's device in their account. For example, the giver's account can include his mother's physical address plus an entry for the IP address of her Apple® iPad or Amazon® Kindle. This option allows the giver to search for both digital and physical gifts through an on-line purchasing environment. In this embodiment, the giver can first identify the electronic product and then select the device (rather than the physical address) for the product. In addition, the interface can enable the giver to add comments, a video message, text, a link, a timing of delivery (for example, on the recipient's birthday or on a holiday such as Christmas morning) or any other feature associated with giving an electronic product. Then the giver can commit the purchase and delivery of the gift. In a simple aspect, the giver commits to purchasing the electronic product and the system then downloads and installs the product onto the chosen recipient device. Optionally, the system can place the download in a queue such that when the recipient's device is communicating with an appropriate network, the download can begin. Accompanying the download can include a message such as “happy birthday.” In one aspect, the recipient does not have to interact at all with the device, it can simply receive the product such that the app or book is ready to use. In another aspect, the recipient may need to interact with a presentation to accept the download. Any messaging can occur to inform the recipient that the download is a book or software application from the giver.

The giver can schedule electronic delivery of a gift for a certain time. It can be granular in that the recipient's calendar via social networking can be made available to the giver. The timing can be specific such as at lunch in between appointments or at the end of the work day. The giver can choose options such as when the recipient is at an airport and ready to board a flight. Any timing or data about the recipient can be made available to the giver such that the impact of the download can be maximized. For example, the download might start when a particular app is chosen on the recipient device. As in the other embodiments above, the system can charge the giver payment account for the cost of the electronic product.

In a second aspect of this embodiment, when the giver identifies a recipient and an electronic product to give to the recipient, the system associates the recipient with a recipient payment and delivery account in which the recipient device is listed as a destination location for the recipient. The system, using the approaches discussed above such as immediate delivery or timed or triggered delivery based on one or more detected events, can charge the recipient payment account and deliver the electronic product to the device selected. Then the cost of the electronic product can be reimbursed through a withdrawal from the giver payment account and a payment made to the recipient payment account.

Additionally, the delivery address for the electronic gift may not be a specific recipient device. In some cases, companies such as Apple® provide the ability to store applications or electronic products such as music or movies in a “cloud” based location such that multiple devices can be synchronized to receive the content. In this aspect of this embodiment, the giver can choose to place the electronic product in the cloud-based location of the recipient. In this case, the delivery can be immediate or timed as well but the access to any particular device of the recipient might be flexible. In this case, the giver can choose to place the electronic product simply in the cloud based storage associated with and accessible by the recipient. Then, the recipient will have the ability when they synchronize a device such that they can download the electronic product to one or more devices that are registered or associated with their cloud-based account.

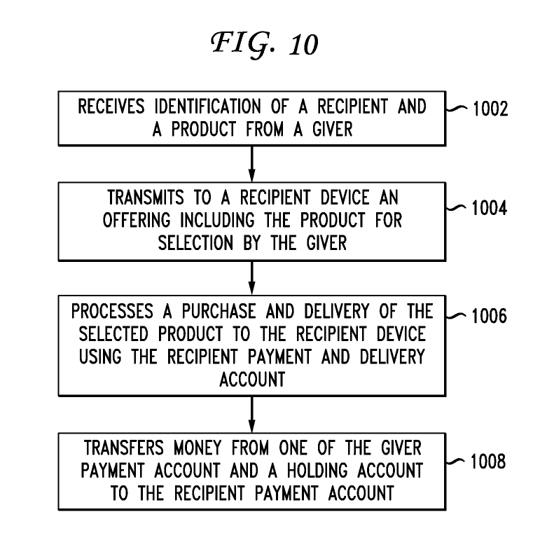

FIG. 10 illustrates a method embodiment of offering an electronic gift to a recipient. A system receives identification of a digital product and a recipient from a giver (1002) having an account at an on-line environment at a first time. The giver account includes a giver payment account. The system transmits at a second time which is later than the first time, to a recipient device an offering including the product for selection by the recipient (1004). The offering, prior to transmitting is associated with a recipient payment and delivery account in an on-line shopping environment. The recipient payment and delivery account includes a recipient payment account and electronic delivery location for the recipient device. The recipient payment account and the giver payment account have no control over one another and each existed prior to the first time. The electronic delivery location can be a device or a server such as a “cloud”. When a product is delivered electronically to the cloud, multiple devices can access the electronic or digital information and the product is not tied to a particular device. Upon receiving a selection from the recipient of a selected product in the offering, the system processes a purchase and delivery of the selected product to the recipient device using the recipient payment and delivery account (1006). The system transfers money from one of the giver payment account and a holding account to the recipient payment account to reimburse at least a portion of a cost of the selected product (1008). At least a portion of the cost of the selected product is either held in the giver payment account or transferred from the giver payment account to the holding account prior to the second time.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data that cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of executable instructions or associated data structures represents examples of corresponding acts implementing the functions described in the steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or a combination thereof) through a communications network. In a distributed computing environment, program modules can reside in local and/or remote memory storage devices.

The various embodiments described above are provided by way of illustration only and should not be construed to limit the scope of the disclosure. For example, the principles herein are applicable to virtual gift cards associated with any type of payment mode, including cash, checks, credit cards, debit cards, loyalty cards, and so forth. The principles herein can be applied to any virtual gift card that can be redeemed by using a payment mechanism to make a purchase in the normal fashion without the recipient using a separate physical card or entering a code. Any function disclosed herein in connection with one embodiment can be blended or incorporated into another embodiment. Given generally that redemption of a virtual gift card is managed by a policy, any policy features discussed above can be blended to provide new policies, although such new policy is not specifically set forth in a single discussion of any embodiment. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving, from a giver, identification of a recipient and identification of a product associated with the recipient at a first time, wherein the giver is associated with a giver payment account;
transmitting, at a second time which is later than the first time, to a recipient device an offering comprising at least the product for selection by the recipient wherein the offering, prior to the transmitting, is associated with a recipient payment and delivery account in an on-line shopping environment wherein the recipient payment and delivery account comprises a recipient payment account and address delivery information for the recipient, wherein the recipient payment account and the giver payment account have no control over one another and each existed prior to the first time;
upon receiving a selection from the recipient of a selected product in the offering, processing a purchase and a delivery of the selected product using the recipient payment and delivery account; and
transferring money from one of the giver payment account and a holding account to the recipient payment account to reimburse at least a portion of a cost of the selected product, wherein at least a portion of the cost of the selected product is either held in the giver payment account or transferred from the giver payment account to the holding account prior to the second time.

2. The method of claim 1, wherein the offering comprises a plurality of products defined by gift requirements specified by the giver.

3. The method of claim 2, wherein the gift requirements further comprise at least one of price range, manufacturer, color, availability and shipping cost.

4. The method of claim 1, wherein the offering is delivered to the recipient electronically.

5. The method of claim 1, wherein the recipient purchases the selected product through the recipient payment account using one-click purchasing at an on-line shopping environment.

6. The method of claim 1, wherein the recipient adds the selected product to a recipient shopping cart using one-click and continues browsing for other products at an on-line shopping environment.

7. The method of claim 6, wherein the selected product is purchased in addition to other products.

8. The method of claim 1, wherein the product comprises at least one of an item and a service.

9. A method comprising:
receiving, from a giver, identification of a recipient and identification of a product associated with the recipient at a first time, wherein the giver is associated with a giver payment and delivery account and the recipient is associated with a recipient payment and delivery account, wherein the giver payment and delivery account comprises a giver payment account and address delivery information for the recipient and the recipient payment and delivery account comprises a recipient payment account, wherein the recipient payment account and the giver payment account have no control over one another and each existed prior to the first time;
transmitting, at a second time which is later than the first time, to a recipient device an offering comprising at least the product for selection by the recipient wherein the offering, prior to the transmitting, is associated with the giver payment and delivery account in an on-line shopping environment
upon receiving a selection from the recipient of a selected product in the offering, processing a purchase of the selected product using one of the giver payment account and a holding account, wherein at least a portion of the cost of the selected product is either held in the giver payment account or transferred from the giver payment account to the holding account prior to the second time, wherein delivery information for the recipient is held in the giver payment and delivery account.

10. The method of claim 9, wherein the product comprises at least one of an item and a service.

11. The method of claim 9, wherein the offering comprises a plurality of products defined by gift requirements specified by the giver.

12. The method of claim 9, wherein the offering comprises a plurality of services added automatically by a server.

13. The method of claim 9, wherein the recipient selects the selected product using one-click at an on-line shopping environment.

14. The method of claim 9, wherein the recipient continues browsing for a product after selecting a service from the offering.

15. A system comprising:
a processor;
a memory storing instructions for controlling the processor to perform steps comprising:
receiving, from a group giver, identification of a group, identification of a recipient and identification of a product associated with the recipient at a first time, wherein each group member is associated with a separate payment account;
transmitting, at a second time which is later than the first time, to a recipient device an offering comprising at least the product for selection by the recipient wherein the offering, prior to the transmitting, is associated with a group giver payment and delivery account wherein the group giver payment and delivery account comprises a group giver payment account and address delivery information for the recipient;
upon receiving a selection from the recipient of a selected product in the offering, processing a purchase and a delivery of the selected product using the group giver payment account; and
transferring money from payment accounts of group members to at least one of the group giver payment account and a holding account, wherein at least a portion of the cost of the selected product is either held in the group giver payment account or transferred from the group giver payment account to the holding account prior to the second time.

16. The system of claim 15, wherein the product is one of an item or a service.

17. The system of claim 15, wherein the recipient opts to continue shopping instead of selecting a product in the offering.

18. The system of claim 15, wherein the group divides the cost of the selected product evenly among the group members, and wherein the group giver is a member of the group.

19. A non-transitory computer-readable storage medium storing instructions which, when executed by a computing device, cause the computing device to deliver a gift electronically, the instructions comprising:
receiving, from a giver, identification of a recipient and identification of a digital product associated with the recipient at a first time, wherein the giver is associated with a giver payment account;
transmitting, at a second time which is later than the first time, to a recipient device an offering comprising at least the product for selection by the recipient wherein the offering, prior to the transmitting, is associated with a recipient payment and delivery account in an on-line shopping environment wherein the recipient payment and delivery account comprises a recipient payment account and electronic delivery location for the recipient device, wherein the recipient payment account and the giver payment account have no control over one another and each existed prior to the first time;
upon receiving a selection from the recipient of a selected product in the offering, processing a purchase and a delivery of the selected product to the recipient device using the recipient payment and delivery account; and
transferring money from one of the giver payment account and a holding account to the recipient payment account to reimburse at least a portion of a cost of the selected product, wherein at least a portion of the cost of the selected product is either held in the giver payment account or transferred from the giver payment account to the holding account prior to the second time.

20. The non-transitory computer-readable storage medium of claim 19, wherein the electronic delivery location is one of a cloud-based storage location associated with the recipient and a device of the recipient.
